(19) United States
(12) Patent Application Publication
(10) Pub. No.: US 2015/0100911 A1
(43) Pub. Date: Apr. 9, 2015

(54) GESTURE RESPONSIVE KEYBOARD AND INTERFACE

(71) Applicant: Dao Yin, Bayside, NY (US)

(72) Inventor: Dao Yin, Bayside, NY (US)

(21) Appl. No.: 14/048,266

(22) Filed: Oct. 8, 2013

(51) Int. Cl. G06F 3/0488

(52) U.S. Cl. CPC G06F 3/04883
USPC 715/773; 715/863

(57) ABSTRACT

Systems, methods, and devices for interpreting slide gestures as input in connection with push-button keyboards and touch-sensitive user interfaces that include virtual keyboards are disclosed herein. These systems and methods cause an arrangement of alternative key inputs to be displayed as a function of a dynamic user input having an initial key-input and a continuous slide gesture such that the arrangement of alternative key inputs is displayed in the direction of the slide gesture prior to cessation of the slide gesture. The systems and methods also select alternative key inputs and perform certain functions according to the initial key touched and the slide gesture. The described techniques can be used in conjunction with a variety of devices, including handheld devices that include touch-screen interfaces, and mechanical keyboards such as desktop computers, tablet computers, notebook computers, handheld computers, personal digital assistants, media players, mobile telephones, and combinations thereof.

### BACKGROUND

The present invention relates generally to input systems, methods, and devices, and more particularly, to systems, methods, and devices for interpreting manual slide gestures as input in connection with keyboards including touch-screen keyboards.

There currently exist various types of input devices for performing operations in electronic devices. The operations, for example, may correspond to moving a cursor and making selections on a display screen. The operations may also include paging, scrolling, panning, zooming, etc. The input devices may include, for example, buttons, switches, keyboards, mice, trackballs, pointing sticks, joy sticks, touch surfaces (including touch pads and touch screens, etc.), and other types of input devices.

Touch screens may include a display, a touch panel, a controller, and a software driver. The touch panel may include a substantially transparent panel that incorporates touch-sensing circuitry. The touch panel can be positioned in front of a display screen or constructed integrally with a display screen so that the touch sensitive surface corresponds to all or a portion of the viewable area of the display screen. The touch panel can detect touch events and send corresponding signals to the controller. Computing systems with mechanical keyboards can also include a display, a software driver, a controller and actuateable keys. In both touch screen and mechanical keyboard implementations, the controller can process these signals and send the data to the computer system. The software driver can translate the touch events into computer events recognizable by the computer system. Other variations of this basic arrangement are also possible.

The computer system can comprise a variety of different device types, such as a pocket computer, handheld computer, or wearable computer (such as on the wrist or arm, or attached to clothing, etc.). The host device may also comprise devices such as personal digital assistants (PDAs), portable media players (such as audio players, video players, multimedia players, etc.), game consoles, smart phones, telephones or other communications devices, navigation devices, exercise monitors or other personal training devices, or other devices or combination of devices.

In some embodiments, touch screens can include a plurality of sensing elements. Each sensing element in an array of sensing elements (e.g., a touch surface) can generate an output signal indicative of the electric field disturbance (for capacitance sensors), force (for pressure sensors), or optical coupling (for optical sensors) at a position on the touch surface corresponding to the sensor element. The array of pixel values can be considered as a touch, force, or proximity image. Generally, each of the sensing elements can work independently of the other sensing elements so as to produce substantially simultaneously occurring signals representative of different points on the touch screen at a particular time.

Recently, interest has developed in touch-sensitive input devices, such as touch screens, for hand-held or other small form factor devices. In such applications, touch screens can be used for a variety of forms of input, including conventional pointing and selection, more complex gesturing, and typing.

Conventional touch-typing techniques may be difficult to use on touch-screen based devices and smaller form factor devices. As a result, users often use “hunt and peck” typing techniques to input text into such devices. Moreover, touch-screen based devices and traditional full-sized keyboards alike are inefficient in that multiple separate key-strokes or finger taps are required to invoke certain characters and functions. What is needed is enhanced textual input on virtual keyboards and traditional keyboards to overcome such challenges.

### SUMMARY

Technologies are presented herein in support of a system and method for managing crowd-based interest in live performances. According to a first aspect, a computer implemented method of generating text input responsive to a dynamic user-touch and slide gesture on a user interface is disclosed. The method includes sensing a user-touch within a keyboard area of the user interface and detecting a slide gesture on the keyboard area following the sensed user-touch. According to the touch and slide gesture, input path data is generated which is representative of an initial touchdown point of the user-touch and a path of the slide gesture on the keyboard area. In addition the method includes analyzing the input path data, and while the slide gesture continues to be sensed, causing an arrangement of alternative key inputs to be displayed on the display. The key inputs are arranged and displayed as a function of a keyboard key located at the initial touchdown point and a direction of the slide gesture. Moreover, the arrangement of alternative key inputs is displayed in the direction of the slide gesture prior to cessation of the slide gesture being sensed. The method also includes the step of, upon completion of the user-touch and slide gesture, generating a text input as a function of the key and the path of the slide gesture, the text input being an executable function that is associated with one or more of the displayed alternative key inputs.

These and other aspects, features, and advantages can be appreciated from the accompanying description of certain embodiments of the invention and the accompanying drawing figures and claims.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIGS. 1A-1B depict a front plan view of a user typing using an exemplary electronic device with touch screen display in accordance with an embodiment of the present invention.

FIGS. 2A-2C depict a front plan view of a user typing using an exemplary electronic device with touch screen display in accordance with an embodiment of the present invention.

FIG. 3 depicts a block diagram of an exemplary tap and slide recognition system in accordance with embodiments of the present invention.

FIG. 4 depicts a flow chart of an exemplary tap and slide gesture detection technique in accordance with embodiments of the present invention.

FIG. 5 depicts an exemplary electronic device with a mechanical keyboard in accordance with embodiments of the present invention.

FIG. 6 depicts various computer form factors that may be used in accordance with embodiments of the present invention.

### DETAILED DESCRIPTION OF CERTAIN EMBODIMENTS OF THE INVENTION

The present disclosure is related to a system and to methods for facilitating gesture responsive user input to a computing system. The system receives user inputs via an input device, such as a keyboard, and interface. The input device can include one or more mechanical or virtual controls that a user can activate to effectuate a desired user input to the computing device. According to a salient aspect, the user can touch a key and perform a continuous gesture in a prescribed direction to invoke the display and/or selection of alternative virtual keys not present on the main keyboard, for example, numbers, foreign letters, symbols, punctuation, words, function keys and the like. According to a salient aspect of the invention, the alternative keys are displayed in the direction of the user's gesture and, in an exemplary virtual keyboard environment, at a distance from the user's fingertip so as to be visible to the user when performing the gesture. Moreover, the alternative keys displayed can vary as a function of the particular key touched and the particular direction of the slide gesture. As such, a user can view and/or select a myriad of characters and functions dynamically with a single touch-slide of a finger and lift-off.

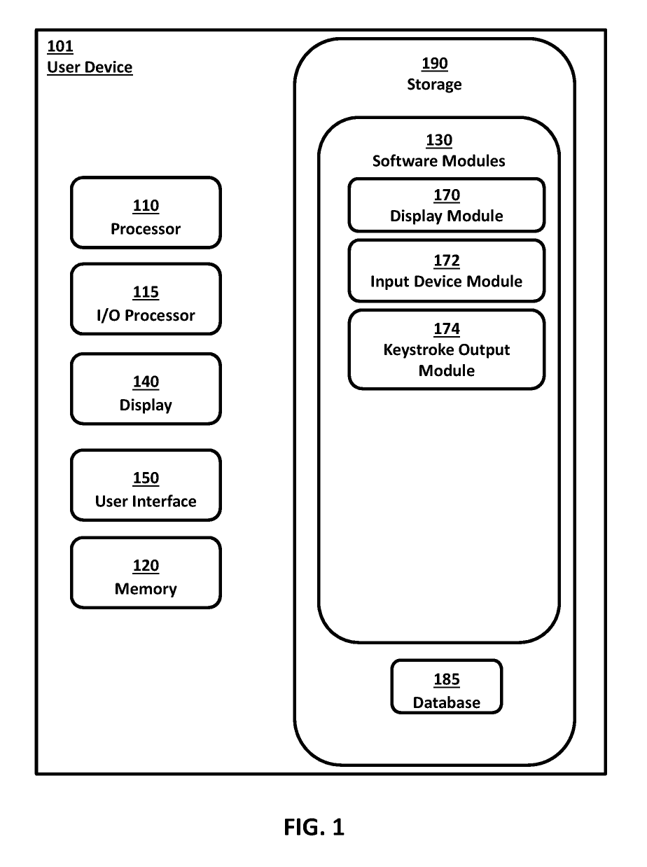

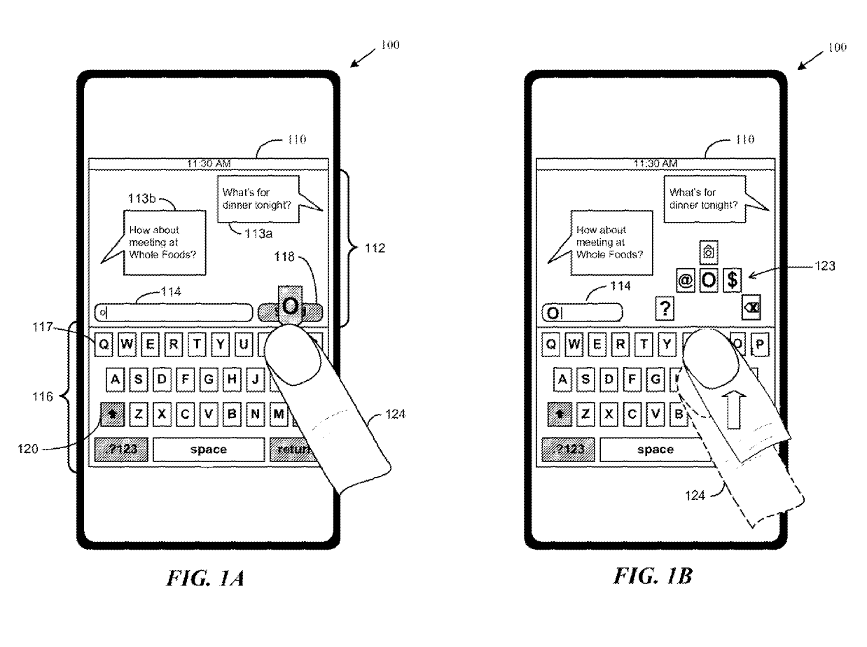

FIG. 1, which is a high-level diagram illustrating an exemplary configuration of a user computing system 100 for facilitating gesture responsive user input and interface 100. User device includes a central processor (CPU) 110, input-output (I/O) processor 115, memory 120, storage 190, user interface 150 and display 140.

CPU may retrieve and execute the program. CPU may also receive input through a touch interface 150 or other input devices such as a mechanical keyboard (Not shown).

In some embodiments, I/O processor 115 may perform some level of processing on the inputs before they are passed to CPU 110. CPU may also convey information to the user through display. Again, in some embodiments, an I/O processor may perform some or all of the graphics manipulations to offload computation from CPU 110. However, CPU and I/O processor are collectively referred herein as the processor

Preferably, memory 120 and/or storage 190 are accessible by processor 110, thereby enabling processor to receive and execute instructions stored on memory and/or on storage. Memory can be, for example, a random access memory (RAM) or any other suitable volatile or non-volatile computer readable storage medium. In addition, memory can be fixed or removable. Storage 190 can take various forms, depending on the particular implementation. For example, storage can contain one or more components or devices such as a hard drive, a flash memory, a rewritable optical disk, a rewritable magnetic tape, or some combination of the above. Storage also can be fixed or removable.

One or more software modules 130 are encoded in storage 190 and/or in memory 120. The software modules can comprise one or more software programs or applications having computer program code or a set of instructions executed in processor 110. Such computer program code or instructions for carrying out operations for aspects of the systems and methods disclosed herein can be written in any combination of one or more programming languages.

Preferably, included among the software modules 130 is a display module 170, an input device module 172, a keystroke output module 174 that are executed by processor 110. During execution of the software modules 130, the processor configures the user device 101 to perform various operations relating to providing augmented content, as will be described in greater detail below.

It can also be said that the program code of software modules 130 and one or more computer readable storage devices (such as memory 120 and/or storage 190) form a computer program product that can be manufactured and/or distributed in accordance with the present invention, as is known to those of ordinary skill in the art.

Also preferably stored on storage 190 is database 185. As will be described in greater detail below, database contains and/or maintains various data items and elements that are utilized throughout the various operations of the system for providing augmented content 100. The information stored in database can include but is not limited to, settings and other electronic information, as will be described in greater detail herein. It should be noted that although database is depicted as being configured locally to user device 101, in certain implementations database and/or various of the data elements stored therein can be located remotely (such as on a remote device or server—not shown) and connected to user device through a network in a manner known to those of ordinary skill in the art.

A user interface 115 is also operatively connected to the processor. The interface can be one or more input device(s) such as switch(es), button(s), key(s), a touch-screen, etc. Interface serves to facilitate the capture of inputs from the user related to the exemplary processes described herein, for example, keystrokes when composing an email.

Display 140 is also operatively connected to processor the processor 110. Display includes a screen or any other such presentation device which enables the system to output electronic media files. By way of example, display can be a digital display such as a dot matrix display or other 2-dimensional display.

By way of further example, interface and display can be integrated into a touch screen display. Accordingly, the display is also used to show a graphical user interface, which can display various data and provide “forms” that include fields that allow for the entry of information by the user. Touching the touch screen at locations corresponding to the display of a graphical user interface allows the person to interact with the device.

It should be understood that the computer system may be any of a variety of types, such as those illustrated in FIG. 6, including desktop computers 601, notebook computers 602, tablet computers 603, handheld computers 604, personal digital assistants 605, media players 606, mobile telephones 607, and the like. Additionally, the computer may be a combination of these types, for example, a device that is a combination of a personal digital assistant, media player, and mobile telephone.

It should be further understood that while the various computing devices and machines referenced herein, including but not limited to user device 101 is referred to herein as an individual/single device and/or machine, in certain implementations the referenced devices and machines, and their associated and/or accompanying operations, features, and/or functionalities can be arranged or otherwise employed across any number of devices and/or machines, such as over a wired or wireless connection, as is known to those of skill in the art.

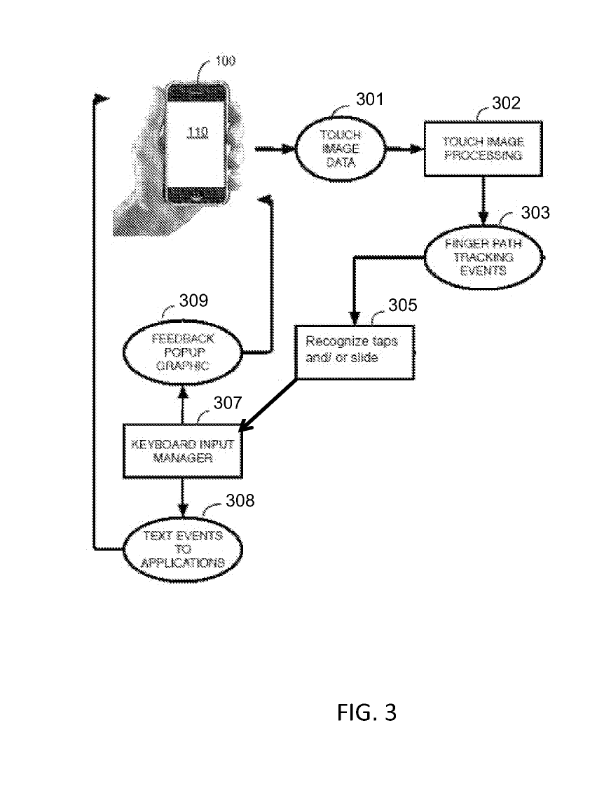

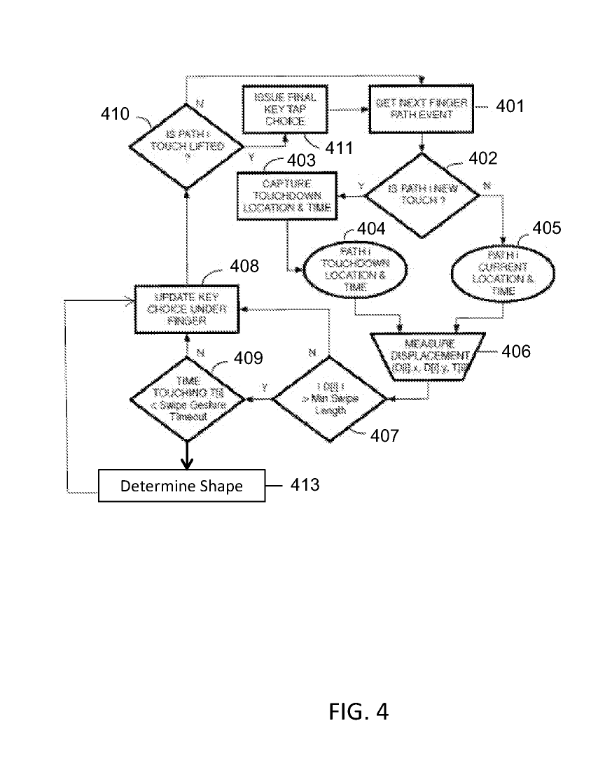

The operation of the system 100 and the various elements and components described above will be further appreciated with reference to the exemplary user interaction according to the examples of the usage of such tap and slide gestures in reference to FIGS. 1A through 6 and further appreciated with reference to the exemplary method for facilitating the method of receiving and processing the tap and slide gestures as described below, in conjunction with FIGS. 3 and 4.

Reference is now made to FIG. 1A, which depicts a front plan view of an exemplary electronic device 100 that implements a touch screen-based virtual keyboard. Electronic device 100 includes a display 110 that also incorporates a touch-screen. The display 110 can be configured to display a graphical user interface (GUI). The GUI may include graphical and textual elements representing the information and actions available to the user. For example, the touch screen may allow a user to move an input pointer or make selections on the GUI by simply pointing at the GUI on the display 110.

As depicted in FIG. 1B, the GUI can be adapted to display a program application that requires text input. For example, a chat or messaging application is depicted. For such an application, the display can be divided into two basic areas. A first area 112 can be used to display information for the user, in this case, the messages the user is sending, represented by balloon 113a and the messages he is receiving from the person he is communicating with, represented by balloon 113b. First area 112 can also be used to show the text that the user is currently inputting in text field 114. First area 112 can also include a virtual “send” button 115, activation of which causes the messages entered in text field 114 to be sent.

A second area can be used to present to the user a virtual keyboard 116 that can be used to enter the text that appears in field 114 and is ultimately sent to the person the user is communicating with. Touching the touch screen at a “virtual key” 117 can cause the corresponding character to be generated in text field 114. The user can interact with the touch screen using a variety of touch objects, including, for example, a finger, stylus, pen, pencil, etc. Additionally, in some embodiments, multiple touch objects can be used simultaneously.

It should be understood that in some implementations, such as a smartphone, because of space limitations, the virtual keys may be substantially smaller than keys on a conventional keyboard. Additionally, not all characters that would be found on a conventional keyboard may be presented. Generally, on existing virtual keyboards, special characters are input by invoking an alternative virtual keyboard causing the user to “hunt and peck” for characters and requiring a plurality of separate taps and/or gestures to enter a particular special character or invoke a particular function.

In some implementations, to provide more convenient and efficient use of certain keys, for example, capitalizing a letter and basic punctuation insertion and basic word processing functions, touch-down of the user's finger (e.g., a touch on a particular virtual key) and directional slide (also referred to herein as “slide gestures,” “slide” or “gesture”) over one or more of the alphabetic keys, the direction of the slide can be used as an alternative to striking certain keys in a conventional manner.

According to exemplary embodiments of the present application, a tap on a virtual key and continuous gesture in a prescribed direction can be used to invoke the display and/or selection of alternative virtual keys not present on the main virtual keyboard, for example, numbers, foreign letters, symbols, punctuation, words, function keys and the like. In addition, the alternative virtual keys can invoke functions, such as, a shift (or capitalized letter), a space, a carriage return or enter function, and a backspace. In addition, the alternative virtual keys can be selected so as to enter multiple characters, symbols and the like with a simple gesture, for example the letter initially selected followed by a punctuation or symbol, say, “q.” or q@. The alternative keys associated with a particular key on the main keyboard and associated with a particular slide direction are pre-defined. As such, a user can view and/or select a myriad of characters and functions dynamically with a single touch-slide of a finger and lift-off.

An example of the usage of such slide gestures can be seen with respect to FIG. 1A through B. In FIG. 1A, the user is entering the text “Ok” in response to a query received through a chat application. The tap-slide input starts with a touchdown of finger 124 in virtual keyboard area 116 on a particular key (e.g., the letter “O”) to be entered as a capital letter. By merely touching the finger 124 on the area of the touch-screen corresponding to the letter “o” on the virtual keyboard 116 and releasing, the letter “o” would be entered in text field 114 as shown in FIG. 1A. However, as shown in FIG. 1B, the user, before lifting the finger, performs a discernible slide gesture towards the top of the screen using finger 124, which causes an arrangement of alternative keys to be displayed on the screen 123. The alternative virtual keys can be displayed in a pre-defined arrangement or “tree structure” in the general direction of the slide gesture. In this example, the tree includes, an “O” (capital O) directly above the finger tip, a “$” symbol diagonally above and to the right of the finger tip, a “@” symbol diagonally to the left, a “carriage return” key to the right, and a “Backspace/delete” symbol to the left. In addition, an “O” and “capslock” symbol can be displayed directly above the capital O and selectable with a longer slide gesture as further described herein.

In accordance with a salient aspect of the invention, the alternative virtual keys 123 are displayed at a set distance from the key in the direction of the slide gesture such that the user can more easily view the various alternative virtual keys even after executing a slide gesture. The user can select a particular alternative virtual key displayed by continuing the gesture in the direction of the particular alternative virtual key that the user desires to select. For example, up if the user desires to enter a capital O, diagonally up and to the right for a question mark, etc. Alternatively the tree structure can be maintained a set distance from the user's finger-tip such that the user can always view the tree structure. In some implementations, the tree structure can move while the gesture is performed until the finger moves a prescribed distance, at which time the tree structure is displayed in a fixed position on the screen, such that the user can physically move the finger to the appropriate alternative virtual key. In addition or alternatively, the user can select a particular key with only a discernible movement in the key's direction.

A liftoff of the finger following the upward slide invokes the entry of the particular virtual key selected by the tap and slide, in this example, liftoff results in a capital “O” being entered in the text field 114.

It should be understood that any number of alternative keys can be associated with a particular virtual key and/or slide direction and a myriad of display arrangements can be implemented in accordance with the disclosed embodiments. In addition or alternatively, certain tap and slides can invoke certain default functions, for example, a tap of a key and a slide down can invoke a space, a tap of the same key and a slide upwards can invoke a capital letter; a tap of the key and a slide left can invoke the backspace/delete function.

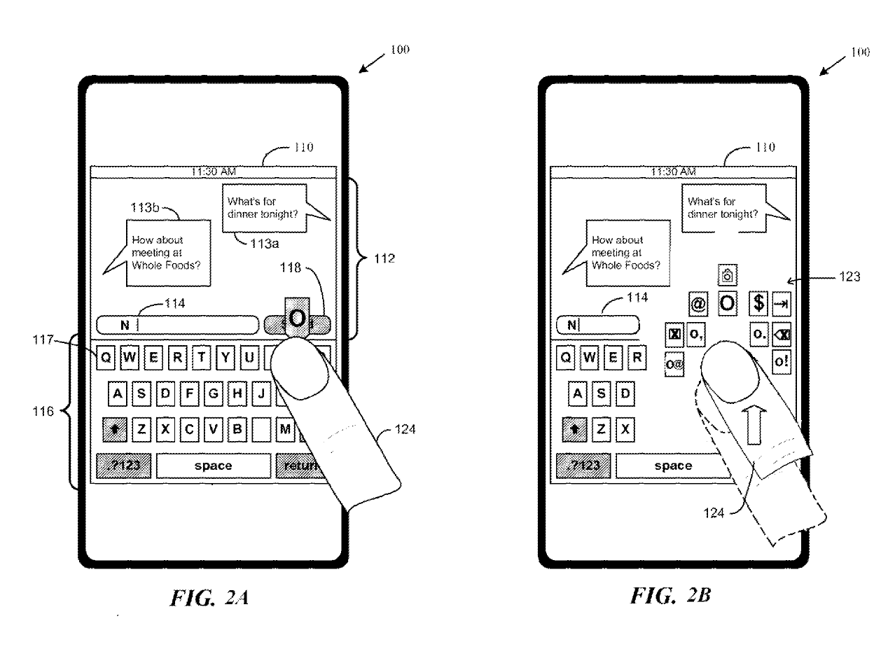

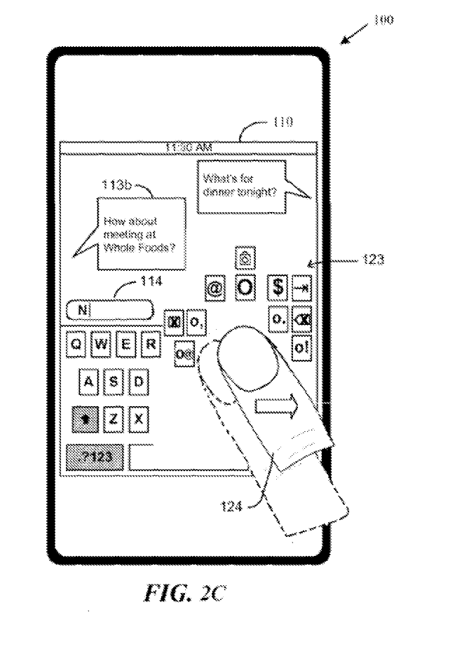

An example of another exemplary usage of such slide gestures can be seen with respect to FIGS. 2A through C. In FIG. 2A, the user is entering the text “No.” in response to a query received through a chat application. Assuming the user has already entered the capital N, the tap-slide input starts with a touchdown of finger 124 in virtual keyboard area 116 on a particular key (e.g., the letter “o”) to be entered followed by a “.” period. As shown in FIG. 2B, the tap-slide can cause a tree of alternative keys to be displayed in a pre-defined arrangement or “tree structure” on the screen. In this example, the tree structure is displayed around the touchdown point on the touchscreen, an “O” (capital O) directly above the finger tip, a “$” symbol diagonally above and to the right of the finger tip, a “@” symbol diagonally up to the left, a “o.” string to the right, and a “o,” string to the left, a “carriage return” key at a further distance to the right, and a “delete” key to further the left. Preferably, the alternative virtual keys are displayed in the direction of the slide gesture. Moreover, the alternative virtual keys can be maintained at a distance from the user's finger-tip in the direction of the slide gesture such that the user can more easily view the various alternative virtual keys even after executing a slide gesture.

As shown in FIG. 2C, the user then, before lifting the finger, performs a discernible slide gesture towards the right of the screen using finger 124. As illustrated in FIG. 2C, liftoff of the finger following the upward slide invokes the entry of the particular virtual key selected by the tap and slide, in this example, liftoff results in a “o.” being entered in the text field 114.

As a further example, as shown in FIGS. 2B and 2C, multiple alternative keys can arranged in the tree structure in the same direction, for example, “o.” and beyond that, the “carriage return” key which is frequently used when typing. In some implementations, the user can select the appropriate virtual key by controlling the length of the slide gesture. For example, a short gesture to the right selects the “o.” key and a longer gesture to the right selects the “carriage return” key. As such, alternative functions and keys can be arranged at different distances and selected accordingly.

In an another implementation, as an alternative to only entering the particular virtual key, say, “o.” with a slide to the right, the user can invoke multiple inputs through more pronounced or choreographed gestures. For example, a discernible yet short slide to the right can cause the “o.” to be entered. A longer slide to the right can cause the “o.” to be entered followed by executing the carriage return function. Alternatively, a discernible slide to the right followed by a slide up toward the top can cause a “o.” to be entered followed by executing the “Tab” function. As such the user can modulate the length of the gesture or perform multi-directional gestures to enter multiple virtual keys with a single dynamic gesture.

Having described an exemplary user's interaction with the system in accordance with the disclosed embodiments, the operation of such a system may be understood with reference to FIG. 3. FIG. 3 shows an exemplary method 300 of dynamically configuring a computing device based on touch gestures. Although the exemplary method is described in relation to a computing device with a touch screen interface, it may be performed by any suitable computing system, such as a computing system having a projected keyboard, and/or a computing system having a push-button keyboard as shown in FIG. 4.

The process begins at step 301-303, where the input device detects a user's interaction with the input device. In one implementation, a touch-screen can detect user interaction and can encode the interaction in the form of input data and submit the data to the I/O processor and/or CPU. In another implementation, the mechanical keyboard can detect a keystroke and/or movement of the keys or keyboard in the horizontal direction. Details regarding, keyboard inputs and touch image acquisition and processing methods would be understood by those skilled in the art. For present purposes, it is sufficient to understand that the processor executing one or more software modules including, preferably, the input device module 172, keyboard input module 176, processes the data representative of the user interactions submitted by the user input device.

The keyboard input module 172 can serve to translate input data into touch events which includes tap events, from a tap and release of a particular key and slide gestures from a touch-down and slide of a fingertip on the input device. The keyboard input module further interprets touch events and generates text events that are sent to the applications, e.g., the entry of letters into text fields and execution of function as described above accordingly. The processor, configured by executing keyboard input module and display module also generates feedback popup graphics, e.g., the display of alternative virtual keys showing according to which letter has been tapped and/or slide gesture as described above.

At step 305 the keyboard input module can serve to recognize the sliding motions that distinguish keyboard taps from slide gestures. If a tap and release is detected, the keyboard input module, at step 307, can generate text events 308 as well as pop up graphics 309 that correspond to the initial contact position. If a slide is detected at step 305, the keyboard input module, at step 307, can generate text events 308 as well as pop up graphics 309 that correspond to the detected slides as a function of the initial contact position.

FIG. 4 shows a combined flow chart for an implementation of keyboard input module 305. In block 401, a finger path event is retrieved. In block 402 it is determined if the new path event corresponds to a new user-touch, e.g., a finger that has just appeared on the surface. If so, the touchdown location and time are captured (block 403), and a path data structure 404 containing this information is created. If the finger path event is not a new touch (e.g., sliding of the finger from the touchdown location), a preexisting path data structure 405 is updated with the current location and time of the touch thereby generating input path data representative of the initial touchdown point of the user-touch and path of the slide gesture on the keyboard area.

In either case, the input path data structure (404 or 405) is analyzed. More specifically the input path data structure is submitted to a direction and displacement measurement process (block 406). The displacement measurement process can determine how much the path has moved in both horizontal direction (D[i].x), how much the path has moved in the vertical direction (D[i].y), and over what time (T[i]). The total distance moved can then be compared to a minimum threshold of movement used to determine whether the touch event is a tap or a slide (block 407). If there is little motion, i.e., less than the threshold, the event is interpreted as a key tap, and the system updates the key choice that corresponds to the location of the finger (block 408).

If the motion exceeds the minimum slide length threshold (block 407), a second test can be performed to determine whether the time of the motion is less than a slide gesture timeout (block 409). This optional time threshold can be used to allow slower motions to permit a user to fine tune key selection. If the time of the motion is greater than the slide gesture timeout threshold, i.e., took too long to be a slide gesture, the event is interpreted as a key tap, and the system updates the key choice that corresponds to the location of the finger (block 408). As an alternative to the time threshold, the system can instead look for an initial velocity at touchdown to distinguish a slide from a tap.

If the path is determined to be a key tap, the key choice currently under the finger is updated (block 408). Then, if a liftoff of the touch is detected (block 410), the final key tap choice is issued (block 411). If a liftoff is not detected (block 410), the next finger path event is detected (block 401), and the process repeats.

Alternatively, if the path has been determined to exceed the minimum length threshold for a slide gesture (block 407) and has been determined to be less than the maximum time threshold for a slide threshold (block 409), the path can be interpreted as a slide event.

In the event of a slide event, the path of the slide gesture can then be further analyzed (block 414) to generate text events (e.g., identify the key choice corresponding to the slide gesture) and/or generate pop up graphics that correspond to the detected slide event. The path of the gesture can by interpreted by analyzing the input path data, preferably, while the slide gesture continues to be sensed, to determine the shape of the user input from initial touch down through the current position. It should be understood that shape can be defined as a vector or series of vectors having a length and corresponding to the path of the user touch. Shape can be determined by analyzing, for each finger path event, how much the path has moved in both horizontal direction (D[i].x), and the vertical direction (D[i].y). For example, in a basic implementation, the shape can be a vector having a starting position and form a generally strait line in a direction, say, at a 45 degree angle from the starting position with a distance. By way of further example, when the user input is not generally unidirectional, say, a slide over and then up, the shape can be a compound vector having a first length at a 90 degree angle from the initial touchdown point, and then a second length in a vertical direction. It should be understood that the shapes can be approximates of the actual user path to account for insubstantial deviations from a straight path.

Using the key located at the initial touchdown point and the determined shape of the user input, the processor configured by the keyboard input module can cause a pop up graphic including an arrangement of alternative key inputs to be displayed. The configured processor can select the appropriate pop up graphic to display by comparing the shape to a look-up table of prescribed shapes each associated with the initial touchdown point and an arrangement of alternative key inputs. If the shape corresponds to one of the prescribed shapes the associated pop-up graphic can be displayed. It should be understood that the prescribed shapes can be approximations of shapes to account for variations in user input paths.

Similarly, the configured processor can also update the current key choice to one or more alternative key choices according to a comparison of the shape to a look-up table of prescribed shapes each being associated with one or more text inputs.

This process can be continued until lift off is detected, at which point a text event is generated according to the current key choice.

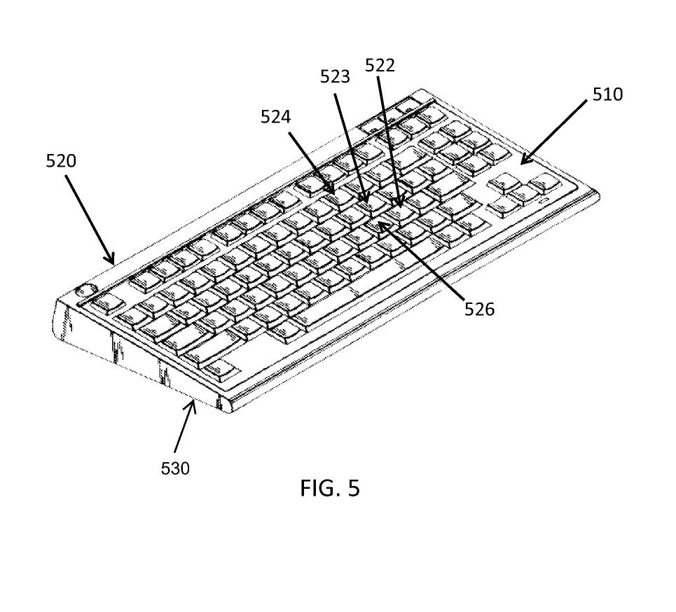

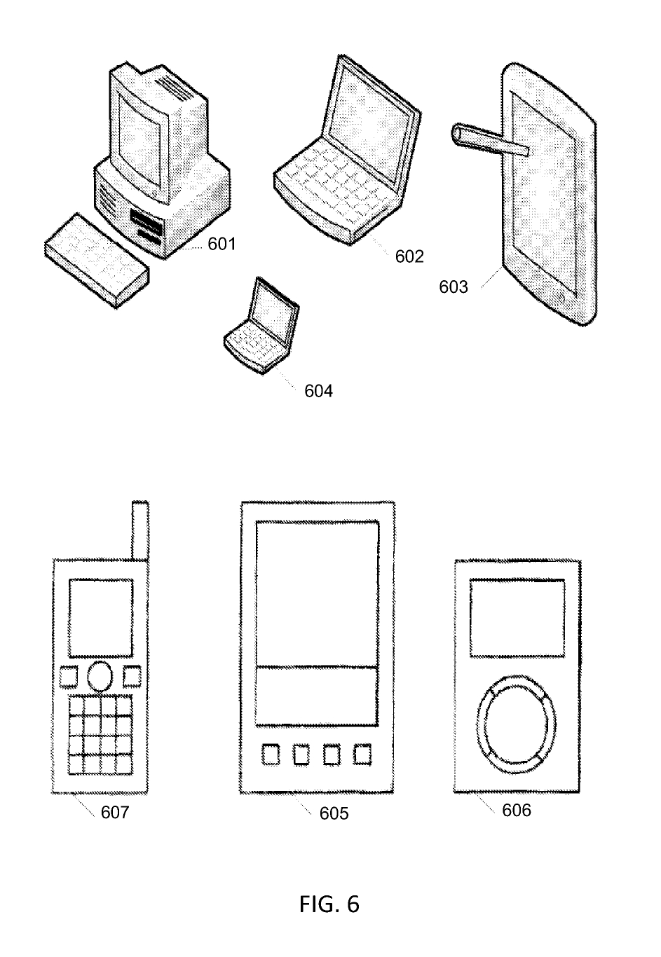

Referring now to FIG. 5, as explained the input device may be touch-sensitive device or physical keyboard 510 having depressible keys 520 and configured to detect touch inputs on the input device (the keyboard). In the case of a physical keyboard 510, a touch input can include physically depressing a key along a vertical axis (e.g., a tap), and/or movement of the key in the horizontal plane (e.g. a slide).

It may be appreciated that in addition or alternatively, a mechanical keyboard may be further configured to recognize tap and slide gestures on multiple keys. Moreover, slide gestures can be recognized from slide gestures on the surface of keys e.g. a gesture or slide across a touch sensitive key surface. The computing device can detect and analyze such touch inputs and execute one or more functions (e.g. inserting alternative text) based on the recognized gestures as described in relation to FIGS. 3-4.

In one exemplary implementation, the input device 510 includes a plurality of depressible keys (e.g., depressible buttons) 520. The keyboard input module may be configured to recognize when a key is pressed or otherwise activated. The adaptive input device may also be configured to recognize a slide gesture from actuation of a key and subsequently actuating one or more adjacent keys, either serially or concurrently or a combination of the foregoing. In this way, the adaptive input device may recognize dynamic user tap and slide gestures as discussed in relation to FIGS. 1A-4. For example, depressing the “K” key 522 and subsequently sliding the finger to depress the “I” key 523 can be recognized as a tap of K and slide having a given length and direction thereby being interpreted as a tap-slide gesture that invokes, say, a capital “K” when the user lifts off the “I” key. By way of further example, continuing the slide gesture from the “I” key to the “8” key 524 can be recognized as a tap of K and slide having a length and direction that can interpreted as a capital K and caps lock function. By way of further example, depressing an “K” key and slide to the left to actuate the “J” key 526 can be interpreted to invoke a delete function.

The slide can be identified on a mechanical keyboard in different ways. In one implementation, the entire keyboard assembly is supported by a housing 530 and is coupled to the housing by one or more piezoelectric crystals (not shown). These crystals can gauge stress in different directions at the time of a key press. As such a strain imported to the crystal while “O” is pressed can be detected. Likewise, strains in multiple directions can be detected by the coupling of the crystals between the keyboard and the support. Alternatively, motion sensors can detect micro-movement between the keyboard 510 at the supporting housing using hall sensors, optical sensors and so on. The common facet of these embodiments is the coordination of a key press registered in a keystroke-processing module with a signal from one or more motion sensors. The alternative key arrangement can be printed on the keyboard or displayed on a display screen in response to the coordinated detection of a key press and movement. A further key press or dwell can be used to select the alternative key function.

Further modifications and alternative embodiments will be apparent to those skilled in the art in view of this disclosure. For example, although the foregoing description has discussed touch screen applications in handheld devices, the techniques described are equally applicable to touch pads or other touch-sensitive devices and larger form factor devices. Accordingly, this description is to be construed as illustrative only and is for the purpose of teaching those skilled in the art the manner of carrying out the invention. It is to be understood that the forms of the invention herein shown and described are to be taken as exemplary embodiments. Various modifications may be made without departing from the scope of the invention.

What is claimed is:

1. A computer implemented method of generating text input responsive to a dynamic user-touch and slide gesture on a user interface, comprising:
sensing a user-touch within a keyboard area of the user interface, using a processor operatively coupled to the user interface and configured by code executing therein;
detecting, by the configured processor, a slide gesture on the keyboard area following the sensed user-touch;
generating input path data representative of an initial touchdown point of the user-touch and a path of the slide gesture on the keyboard area;
analyzing the input path data, and while the slide gesture continues to be sensed, causing an arrangement of alternative key inputs to be displayed as a function of a keyboard key located at the initial touchdown point and a direction of the slide gesture, wherein the arrangement of alternative key inputs is displayed in the direction of the slide gesture prior to cessation of the slide gesture being sensed; and
upon completion of the user-touch and slide gesture, generating a text input as a function of the key and the path of the slide gesture, wherein the text input executes functions associated with one or more of the displayed alternative key inputs.

2. The method of claim 1, wherein the user interface is a touch interface and the keyboard area is a virtual keyboard area.

3. The method of claim 1, wherein the step of generating a text input is performed prior to cessation of the slide gesture being detected.

4. The method of claim 2, wherein the prescribed arrangement of alternative key inputs are caused to be displayed in the direction of the slide gesture.

5. The method of claim 2, wherein the prescribed arrangement of alternative key inputs is caused to be displayed a distance from a current point of user contact while performing the slide gesture.

6. The method of claim 1, wherein the alternate key inputs in the prescribed arrangement are selected for display as a function of the direction of the slide gesture.

7. The method of claim 1, wherein the arrangement of alternate key inputs displayed varies as a function of the direction of the slide gesture.

8. The method of claim 2 wherein the touch interface is a touch screen.

9. The method of claim 1, wherein the step of detecting the user-touch and slide gesture, further comprises:
receiving, by the configured processor, user input data from the user interface;
processing the user input data to generate one or more input path events, wherein the one or more input path events are representative of the position of the user-touch acquired over time;
determining a displacement of the one or more input path events; and
detecting the slide gesture if the displacement exceeds a predetermined threshold.

10. The method of claim 1, wherein the step of generating the text input further comprises:
identifying a key which corresponds to the initial touchdown point;
comparing the one or more input path events to a database of prescribed input path events, wherein each prescribed input path event is associated with one of the displayed alternative key inputs and the identified key;
if the one or more input path events matches one or more prescribed input path events, generating a text input according to the one or more alternative key inputs associated with the prescribed input path event.

11. The user input device of claim 9 wherein each of the one or more input path events and prescribed input path events include a magnitude and direction.

12. The user input device of claim 1, wherein the text input executes functions associated with a plurality of the alternative key inputs displayed.

13. The user input device of claim 1 wherein the user interface is a mechanical keyboard, and wherein the keyboard area includes a plurality of manual keys that are actuatable along a vertical axis and a plurality of directions in a horizontal plane.

14. The user input device of claim 12, wherein the step of sensing a user touch comprises sensing actuation a particular manual key along the vertical axis, and wherein the step of sensing the slide gesture further comprises sensing actuation of at least the particular manual key in the horizontal axis.

15. A user input device for generating text inputs responsive to a dynamic user-touch and slide gesture on a user interface, the input device comprising:
a storage medium;
a user interface including a keyboard area; and
a processor operatively coupled to the storage medium and the user interface, the processor configured by executing one or more software modules stored on the storage medium, including:
an input module configured to sense the user-touch to the keyboard area and detect the slide gesture on the keyboard area and generate input path data representative of an initial touchdown point and a path of the slide gesture on the keyboard area,
a keyboard control module configured to analyze the input path data, and while the slide gesture continues to be detected, cause an arrangement of a plurality of alternative key inputs to be displayed as a function of the touchdown point and a direction of the slide gesture, and
the keyboard control module being further configured to generate a text input as a function of the touchdown point and the path of the slide gesture, wherein the text input corresponds to one of the plurality of alternative key inputs displayed.

16. The user input device of claim 13, wherein the user interface is a touch interface and the keyboard area is a virtual keyboard area.

17. The user input device of claim 13, wherein the prescribed arrangement of alternative key inputs are caused to be displayed in the direction of the slide gesture.

18. The user input device of claim 13, wherein the prescribed arrangement of alternative key inputs are caused to be displayed a distance from a current point of user contact while performing the slide gesture.

19. The user input device of claim 13, wherein the alternate key inputs in the prescribed arrangement are selected for display as a function of the direction of the slide gesture.

20. The user input device of claim 13, wherein the arrangement of alternate key inputs displayed varies as a function of the direction of the slide gesture.

21. The user input device of claim 14, wherein the touch interface is a touch screen.

22. The user input device of claim 13, wherein the processor configured by executing the input module detects user-touch and a slide gesture, by:
acquiring user input data from the user interface;
processing the user input data to generate one or more input path events, wherein the one or more input path events are representative of the position of the user-touch acquired over time;
determine a displacement of the one or more input path events; and
detect the slide gesture if the displacement exceeds a predetermined threshold.

23. The user input device of claim 13 wherein the processor configured by executing the keyboard control module generates the one or more key inputs by:
identifying a key which corresponds to the initial touchdown point;
comparing the one or more input path events to a database of prescribed input path events, wherein each prescribed input path event is associated with one of the displayed alternative key inputs and the identified key;
if the one or more input path events matches a particular prescribed input path event generating a text input according to a particular alternative text input associated with the particular prescribed input path event.

24. The user input device of claim 13 wherein the user interface is a mechanical keyboard, and wherein the keyboard area includes a plurality of manual keys that are actuatable along a vertical axis and a plurality of directions in a horizontal plane.
